(19) United States
(12) Patent Application Publication
(10) Pub. No.: US 2017/0067651 A1
(43) Pub. Date: Mar. 9, 2017

(54) BUILT-IN COOKING HOB

(71) Applicant: WHIRLPOOL CORPORATION, Benton Harbor, MI (US)

(72) Inventors: Himanshu G. Khokle, Nagpur (IN); Luca Leonardi, Oleggio (IT); Pradeep S. Thorat, Miraj (IN)

(73) Assignee: WHIRLPOOL CORPORATION, BENTON HARBOR, MI (US)

(21) Appl. No.: 15/255,923

(22) Filed: Sep. 2, 2016

(30) Foreign Application Priority Data
Sep. 3, 2015 (EP) 15183701.0

(51) Int. Cl. F24C 15/30; H05B 6/12; F24C 15/10

(52) U.S. Cl. CPC F24C 15/30; F24C 15/10; H05B 6/1209

(57) ABSTRACT

A built-in cooking hob includes a main body configured to be installed in an opening of a counter top. An upper plate abuts a peripheral edge of the opening, and is fastened to the main body. The upper plate includes a lower face having a plurality of hinged elements configured to assume a first configuration substantially orthogonal to the upper plate and a second configuration substantially parallel to the upper plate. Removable fasteners are disposed between the hinged elements and the main body in the second configuration for fastening the main body to the upper plate.

### CROSS-REFERENCE TO RELATED APPLICATION

This application claims priority to European Patent Application No. EP 15183701.0, filed Sep. 3, 2015, entitled “FASTENING MEANS FOR BUILT-IN COOKING HOB,” the disclosure of which is incorporated herein by reference in its entirety.

### FIELD OF THE DISCLOSURE

The present disclosure relates to a built-in cooktop having a main body configured to be installed in an opening of a counter top and to be fastened to an upper plate which abuts the peripheral edge of the opening.

### BACKGROUND OF THE DISCLOSURE

It is an object of the present disclosure to provide a built-in cooktop of the type mentioned at the beginning of the description which assures a quick and reliable assembly on the counter-top or kitchen table.

With the solution set forth in this disclosure, the main body can maintain dimensions substantially corresponding to the dimensions of the opening in the counter-top. This is an important advantage in view of the amount of components to be contained in the main body, particularly in modern induction cooktops. Moreover, with this solution, the main body can be removed from the bottom and, by using mechanical fasteners or the like for fastening the main body to the upper plate, a more reliable mounting is assured.

These and other features, advantages, and objects of the present disclosure will be further understood and appreciated by those skilled in the art by reference to the following specification, claims, and appended drawings.

### SUMMARY OF THE DISCLOSURE

According to one aspect of the present disclosure, a built-in cooking hob includes a main body configured to be installed in an opening of a counter top. An upper plate abuts a peripheral edge of the opening and is fastened to the main body. The upper plate includes a lower face having a plurality of hinged elements configured to assume a first configuration substantially orthogonal to the upper plate and a second configuration substantially parallel to the upper plate. Removable fasteners are disposed between the hinged elements and the main body in the second configuration for fastening the main body to the upper plate.

According to another aspect of the present disclosure, a built-in cooking hob includes a main body configured to be installed in an opening of a counter top. An upper plate abuts a peripheral edge of an opening and is fastened to the main body. The upper plate includes a lower face having a plurality of hinged elements configured to assume a first configuration substantially orthogonal to the upper plate and a second configuration substantially parallel to the upper plate. Removable fasteners are disposed between the hinged elements and the main body in the second configuration for fastening the main body to the upper plate. Each of the plurality of hinge elements presents a root portion configured to be removably fastened to a bracket operably coupled with a lower face of the upper plate.

According to yet another aspect of the present disclosure, a built-in cooking hob includes a main body configured to be installed in an opening of a counter top. An upper plate is fastened to the main body. The upper plate includes a lower face having a plurality of hinged elements operable during assembly between a first configuration substantially orthogonal to the upper plate and a second configuration substantially parallel to the upper plate. Each of the plurality of hinge elements presents a root portion configured to be removably fastened to a bracket operably coupled with a lower face of the upper plate.

These and other features, advantages, and objects of the present disclosure will be further understood and appreciated by those skilled in the art by reference to the following specification, claims, and appended drawings.

### BRIEF DESCRIPTION OF THE DRAWINGS

Further features and advantages according to the present disclosure will become clear with reference to the attached drawings in which:

FIG. 1 is a perspective view of a cooking hob according to the disclosure installed on a counter-top of a kitchen piece of furniture;

FIG. 2 is a detail of cooking hob of FIG. 1 from the bottom thereof;

FIG. 3 is a cross-section perspective view along line III-III of FIG. 1;

FIG. 4 is a detail view of FIG. 3 from a different point of view;

FIG. 5 is a view similar to FIG. 4 in a configuration for removal/insertion of the main body; and

FIG. 6 is a perspective view of a hinged flap element used in the cooking hob of the above FIGS. 1-5.

### DETAILED DESCRIPTION OF EMBODIMENTS

The present illustrated embodiments reside primarily in combinations of method steps and apparatus components related to a display mirror. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

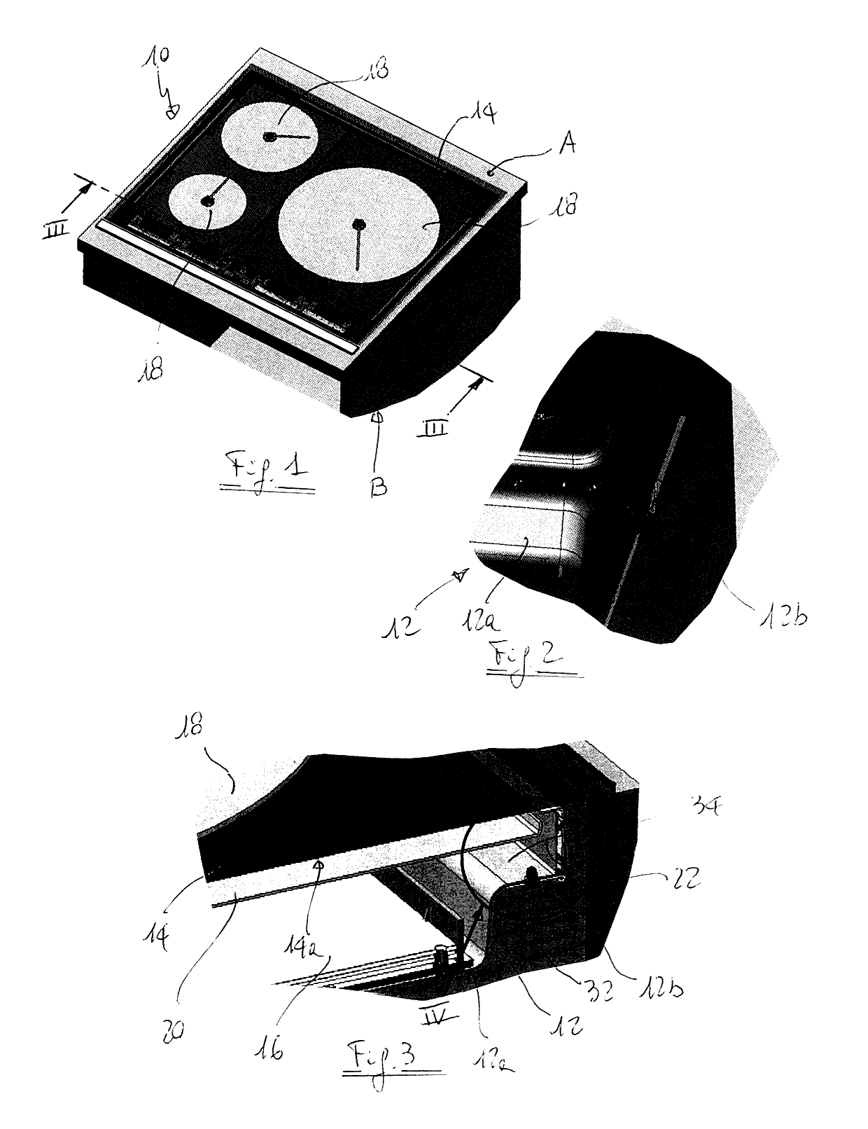

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer of the display mirror, and the term “rear” shall refer to the surface of the element further from the intended viewer of the display mirror. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

With reference to FIGS. 1-5, an induction cooking hob 10 is installed in a corresponding opening of a counter top A of a piece of kitchen furniture B. The cooking hob 10 comprises a tray-shaped main body 12 covered by a glass upper plate 14 (in FIG. 1 the transparency of the glass upper plate 14 is higher than usual so that internal components are visible). In the main body 12 several components are contained, as printed circuit boards 16 (FIG. 3) where electronic components (not shown) are mounted, and induction coils 18 placed on support plates 20. As it is shown in FIGS. 2-5 the main body 12 presents a bottom portion 12a and an upper portion 12b whose dimensions are bigger than the bottom portion 12a. This is required in order to house bigger induction coils 18 which increase the usability of the cooking hob 10.

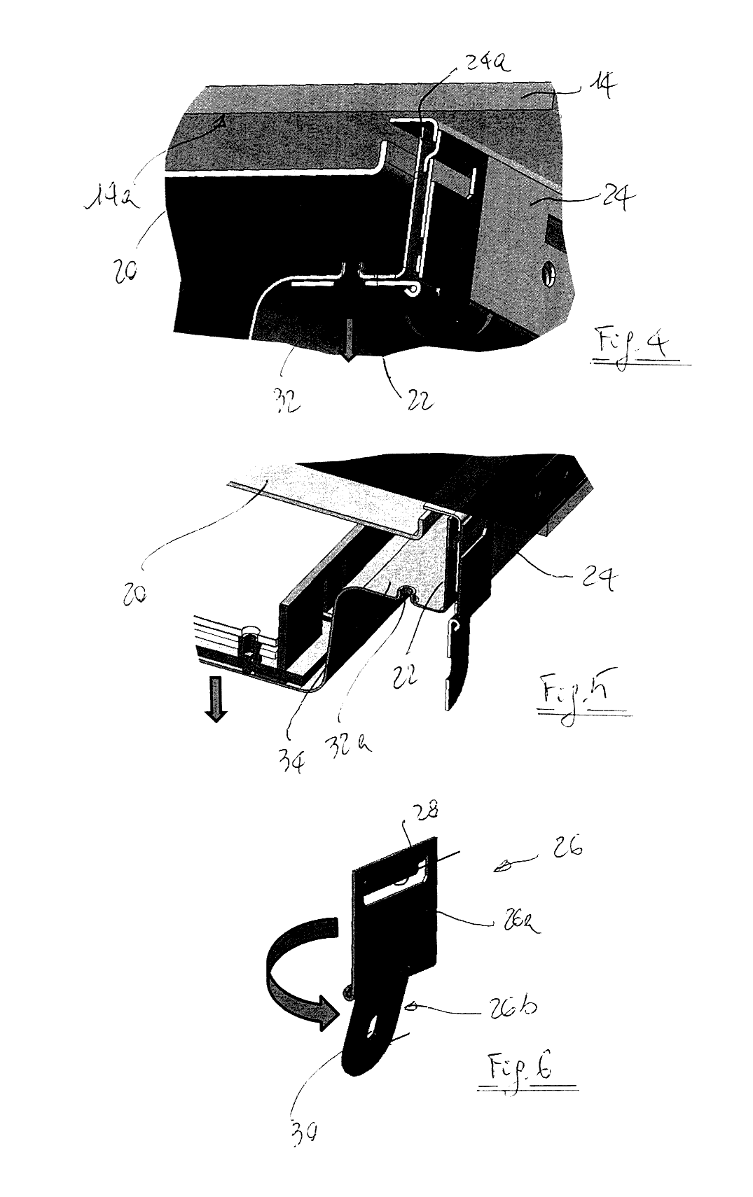

As shown in FIGS. 3 and 4, the main body 12 presents upper side walls 22 which are designed to be inserted at a small distance adjacent the edges of the opening (in the example shown in the drawings the opening is defined by vertical walls of the kitchen furniture B). The glass upper plate 14 presents, on its lower surface 14a, two parallel mounting brackets 24 (for instance fixed by adhesive) whose dimensions are such to correspond to the dimensions of the side walls 22 of the main body 12, so that they face from the outside such walls (configuration shown in FIGS. 3 to 5). The above brackets 24 (which may be four in total) presents slots 24a in which hinge devices 26 are installed. Each hinge device 26 presents a root portion 26a having a shaped wings 28 configured to be inserted into the corresponding slot 24a of the bracket 24 and a rotating flap 26b with a hole 30.

When the main body 12 and all the components contained therein has to be removed from the kitchen furniture B, it is only necessary to unscrew a few screws 32 (desirably screws which can be manually driven) which cooperate with corresponding holes 32a of a peripheral flange 34 bridging the bottom portion 12a and the upper portion 12b of the main body 12 (FIG. 4). When the screws 32 are removed, the rotating flaps 26b of the hinge devices 26 can be rotated downward (FIG. 5) so that the main body 12 can be removed from below. In such rotation each flap 26b passes from a configuration substantially parallel to the glass upper plate 14 (and to the counter top A) to a configuration substantially orthogonal to the glass upper plate 14. The rotation of the flaps is driven or helped by gravity.

In an alternative version the rotating flaps 26b can be hinged directly to brackets 24. Moreover, even if the above example shows an induction cooking hob, the solution according to the disclosure may be used with radiant heaters as well.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A built-in cooking hob comprising:
a main body configured to be installed in an opening of a counter top;
an upper plate which abuts a peripheral edge of the opening, and which is fastened to the main body, the upper plate including a lower face having a plurality of hinged elements configured to assume a first configuration substantially orthogonal to the upper plate and a second configuration substantially parallel to the upper plate; and
wherein removable fasteners are disposed between the hinged elements and the main body in the second configuration for fastening the main body to the upper plate.

2. The built-in cooking hob of claim 1, wherein the plurality of hinged elements are hinged to brackets fixed to a lower face of the upper plate.

3. The built-in cooking hob of claim 1, wherein each of the plurality of hinge elements presents a root portion configured to be removably fastened to a bracket operably coupled with the lower face of the upper plate.

4. The built-in cooking hob of claim 3, wherein each of the plurality of hinged elements defines a hole configured to cooperate with a mechanical fastener.

5. The built-in cooking hob of claim 4, wherein the mechanical fastener is a manually driven screw.

6. The built-in cooking hob of claim 1, wherein the main body includes upper side walls designed for insertion adjacent edges of the opening.

7. The built-in cooking hob of claim 2, wherein the bracket includes a slot for reception of one hinge element.

8. The built-in cooking hob of claim 1, wherein each of the plurality of hinged elements includes a rotating flap defining a hole therethrough.

9. A built-in cooking hob comprising:
a main body;
an upper plate which abuts a peripheral edge of an opening, and which is fastened to the main body, the upper plate including a lower face having a plurality of hinged elements configured to assume a first configuration substantially orthogonal to the upper plate and a second configuration substantially parallel to the upper plate;
wherein removable fasteners are disposed between the hinged elements and the main body; and
wherein each of the plurality of hinge elements presents a root portion configured to be removably fastened to a bracket operably coupled with a lower face of the upper plate.

10. The built-in cooking hob of claim 9, wherein the plurality of hinged elements are hinged to the brackets operably coupled with the lower face of the upper plate.

11. The built-in cooking hob of claim 9, wherein each of the plurality of hinged elements defines a hole configured to cooperate with a mechanical fastener.

12. The built-in cooking hob of claim 10, wherein the mechanical fastener is a manually driven screw.

13. The built-in cooking hob of claim 9, wherein the main body includes upper side walls designed for insertion adjacent edges of the opening.

14. The built-in cooking hob of claim 9, wherein the bracket includes a slot for reception of one hinge element.

15. The built-in cooking hob of claim 9, wherein each of the plurality of hinged elements includes a rotating flap defining a hole therethrough.

16. A built-in cooking hob comprising:
a main body configured to be installed in an opening of a counter top;
an upper plate fastened to the main body, the upper plate including a lower face having a plurality of hinged elements operable during assembly between:
a first configuration substantially orthogonal to the upper plate; and
a second configuration substantially parallel to the upper plate; and
wherein each of the plurality of hinge elements presents a root portion configured to be removably fastened to a bracket operably coupled with a lower face of the upper plate.

17. The built-in cooking hob of claim 16, wherein each of the plurality of hinged elements defines a hole configured to cooperate with a mechanical fastener.

18. The built-in cooking hob of claim 17, wherein the mechanical fastener is a manually driven screw.

19. The built-in cooking hob of claim 16, wherein the main body includes upper side walls designed for insertion adjacent edges of the opening.

20. The built-in cooking hob of claim 16, wherein the bracket includes a slot for reception of one hinge element.
